(19) United States
(12) Patent Application Publication
(10) Pub. No.: US 2026/0073490 A1
(43) Pub. Date: Mar. 12, 2026

(54) MAKING AN AUGMENTED TRAINING DATA SET FOR TRAINING A MACHINE LEARNING DATA MODEL TO INTERPRET GROUND PENETRATING RADAR B-SCANS

(71) Applicant: SMARTAUGER, INC., Wadsworth, OH (US)

(72) Inventor: Nathan Stein, Seattle, WA (US)

(21) Appl. No.: 18/828,645

(22) Filed: Sep. 9, 2024

(51) Int. Cl. G06T 5/73; G01S 13/89; G06T 5/20

(52) U.S. Cl. CPC G06T 5/73; G01S 13/89; G06T 5/20; G06T 2207/10044; G06T 2207/20024

(57) ABSTRACT

Methods of making a partially synthetic data set for training an AI to correct for noise in GPR B-scan data. The methods mimic noise observed in real B-scans. Original B-scans are augmented with a plurality of permutations of synthetic noise. Methods include processes for (i) mimicking observed blurring in B-scan images resulting from variations in translational speed of the detector, (ii) mimicking observed RF interference in B-scan images, and/or (iii) mimicking observed vertical shifts resulting from movement of the GPR unit due to uneven ground. Methods can further include processes for low-pass filtering B-scan images to remove inductive emission interference and artifacts resulting from dynamic range limitations.

### I. BACKGROUND OF THE INVENTION

### A. Field of Invention

The invention generally relates to data augmentation methods for training artificial intelligence data models.

### B. Description of the Related Art

As artificial intelligence (AI) becomes more widespread, the need for new methods of training AI data models continues to increase. While certain principles apply generally to data model training, each application of artificial intelligence presents its own unique technical problems. For example, applying artificial intelligence to recognize targets in ground penetrating radar (GPR) B-scan data requires one to account for numerous variables affecting radar signals. Targets may vary in size, shape, orientation, material, and distance from the antenna. The soil in which targets are buried may vary substantially in composition, moisture content, and conductivity. Numerous interfaces may be present, causing reflections and other aberrations.

The frequency content and signal strength of the radar source may vary from one radar to another, and even one scan to another by the same radar. B-scan characteristics are further affected by antenna design, the mode and process of data collection, and signal processing. In short one must account for a very large number of variables in order to effectively train an AI to reliably recognize targets under a useful range of conditions. Therefore the necessary training data set is correspondingly large.

While it is theoretically possible to collect such a large amount of real GPR data, the time and cost to do so is substantial, and can even be prohibitive. It is known to generate synthetic data to decrease time and cost requirements for generating a suitable training data set. To do so, generally, one identifies a set of parameters that are expected to vary from one scan to the next, and then devises test conditions to collect discrete data points over the variables' expected ranges. Unfortunately identifying all significant variables is non-trivial, as is devising methods to simulate their variation.

What is needed in the field is improved methods of generating synthetic GPR data for training AI data models to identify targets in B-scan data. Some embodiments of the present invention may provide one or more benefits or advantages over the prior art.

### II. SUMMARY OF THE INVENTION

Some embodiments may relate to methods of supplementing a training data set with synthetic data, including methods of generating synthetic data. Embodiments can include processes for mimicking observed blurring in B-scan images resulting from variations in translational speed of the detector. Embodiments can include processes for mimicking observed RF interference in B-scan images. Embodiments can include processes for mimicking observed vertical shifts resulting from movement of the GPR unit due to uneven ground. Embodiment can include processes for low-pass filtering B-scan images to remove inductive emission interference and artifacts resulting from dynamic range limitations. Embodiments can include one or more of the methods described herein.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof, wherein like reference numerals indicate like structure, and wherein:

FIG. 1 is a schematic illustration of a process according to a column-wise noise augmentation of the invention;

FIG. 1.1 is an actual GPR B-Scan exhibiting several kinds of noise;

FIG. 1.2A is an original GPR B-Scan recorded under realistic operating conditions;

FIG. 1.2B is the GPR B-Scan of FIG. 1.2A after augmentation;

FIG. 1.3A is an original GPR B-Scan recorded under realistic operating conditions;

FIG. 1.3B is the GPR B-Scan of FIG. 1.3A after augmentation;

FIG. 2 is a schematic illustration of a process according to a radio frequency (RF) noise augmentation of the invention;

FIG. 3 is a schematic illustration of a process according to a column-shifting artifact augmentation of the invention;

FIG. 4 is a schematic drawing of a dewow process according to an embodiment of the invention; and

FIG. 5 is an average power spectrum of a GPR B-scan.

### IV. DETAILED DESCRIPTION OF THE INVENTION

As used herein the terms “embodiment”, “embodiments”, “some embodiments”, “other embodiments” and so on are not exclusive of one another. Except where there is an explicit statement to the contrary, all descriptions of the features and elements of the various embodiments disclosed herein may be combined in all operable combinations thereof.

Language used herein to describe process steps may include words such as “then” which suggest an order of operations; however, one skilled in the art will appreciate that the use of such terms is often a matter of convenience and does not necessarily limit the process being described to a particular order of steps.

Conjunctions and combinations of conjunctions (e.g. “and/or”) are used herein when reciting elements and characteristics of embodiments; however, unless specifically stated to the contrary or required by context, “and”, “or” and “and/or” are interchangeable and do not necessarily require every element of a list or only one element of a list to the exclusion of others.

Terms of degree, terms of approximation, and/or subjective terms may be used herein to describe certain features or elements of the invention. In each case sufficient disclosure is provided to inform the person having ordinary skill in the art in accordance with the written description requirement and the definiteness requirement of 35 U.S.C. 112.

As used herein the term noise includes, but is not limited to, random signal variations. Noise also includes artifacts and anomalies arising from systematic sources like equipment configurations and limitations, and mathematical image reconstruction techniques, irregular movement of the radar during measurement, and so on. All image distortions are encompassed by the term “noise”, as this word is used throughout this disclosure.

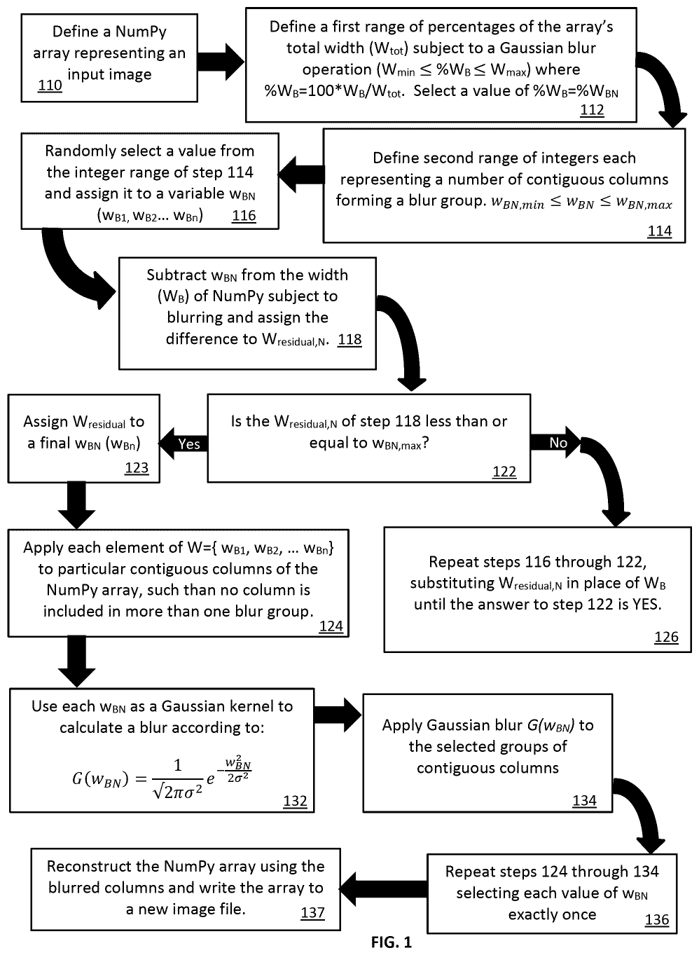

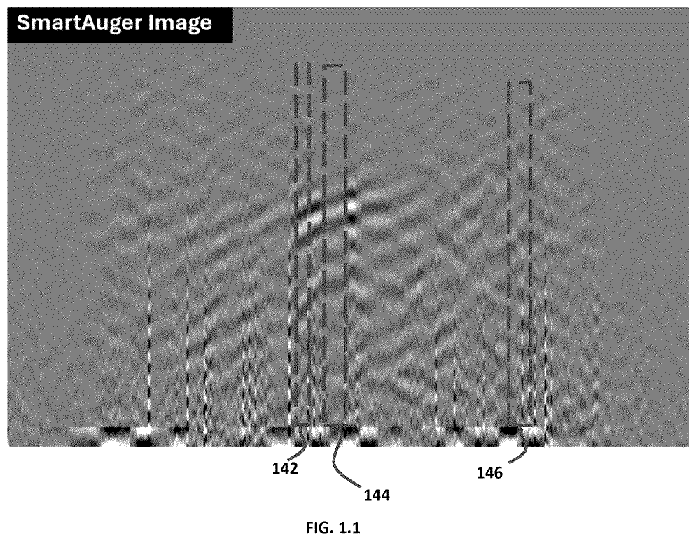

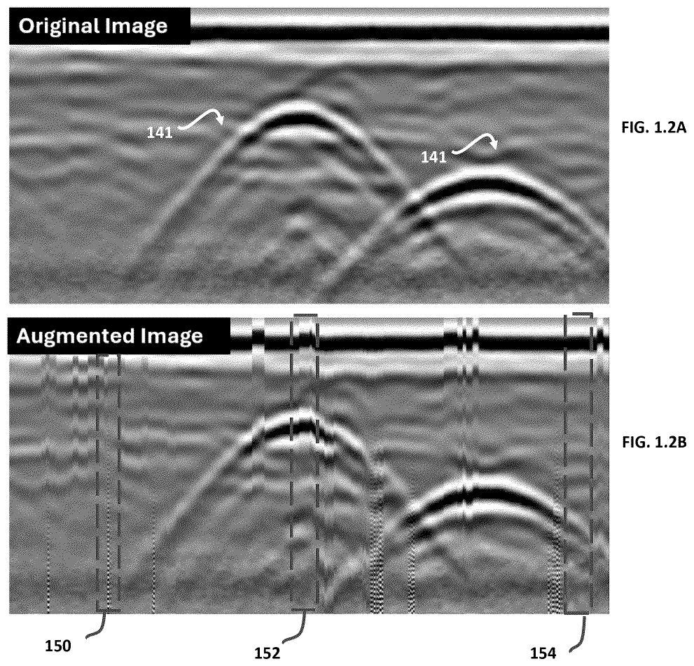

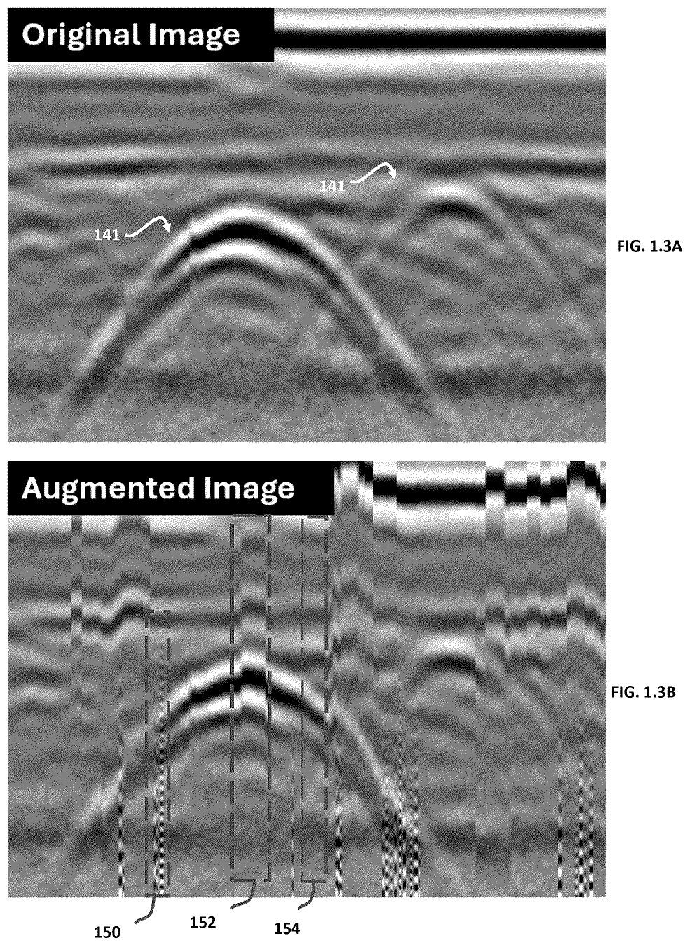

Referring now to the drawings wherein the showings are for purposes of illustrating embodiments of the invention only and not for purposes of limiting the same, FIG. 1.1 is an original, unaugmented, B-Scan image collected under realistic operating conditions. Black represents the lowest signal strength and white represents the highest signal strength. Accordingly, the shallowest signals are found near the bottom, and depth increases vertically. The B-Scan image in FIG. 1.1 exhibits several kinds of noise that are synthesized by embodiments of the invention. Box 142 encloses a group of columns exhibiting vertical shift noise due to movement of the antenna. Box 144 encloses a group of blurred columns, which results from changes in translational speed of the antenna. Box 146 encloses column exhibiting RF interference noise, which is characterized by thin column groups with a repeating black/white pattern that decreases in intensity with distance from the antenna.

Other B-scan images shown in FIGS. 1.2A through 1.3B are inverted relative to FIG. 1.1. That is, distance from the antenna increases as you go down the vertical axis. FIGS. 1.2A and 1.2B and FIGS. 1.3A and 1.3B are before-and-after pairs of B-Scans showing original, unaltered, B-Scans in 1.2A and 1.3A and augmented versions of the same images in FIGS. 1.2B and 1.3B. In FIG. 1.2B an augmented version of FIG. 1.2A is shown. The hyperbolas 141 labeled in FIGS. 1.2A and 1.3A indicate reflections from buried objects e.g., utility pipes or conduits. These same signals are also visible in the augmented versions of FIGS. 1.2A and 1.3A along with noise distorting or obstructing the signals. Box 150 encloses synthetic RF noise, box 152 encloses synthetic vertical shift, and box 154 encloses synthetic blur. The same kinds of synthetic noise are also shown in FIG. 1.3B in comparison to the original image in FIG. 1.3A. Specifically, RF (150), vertical shift (152) and blur (154) are each enclosed in boxes in FIG. 1.3B.

With respect to the RF noise in box 150, the intensity of the noise spike exhibits the opposite relationship to depth versus the rest of the B-scan. The RF noise appears to increase in intensity with distance from the antenna. The reason is that RF noise is introduced directly into the receiver. As a result, the relative intensity of RF interference increases in the deeper parts of the B-scan where true subsurface reflections are weaker. Additionally, the B-scan images are depth corrected to produce a more uniform image. While depth correction reduces the gradient of true reflection signals, it also scales the RF interference, which is already uniform. The result is to make the RF interference appear to increase with depth. This artifact is replicated in the synthetic data according to processes of the invention taught herein.

### Synthetic Column Blur Noise

FIG. 1 is a schematic diagram of a data augmentation method simulating noise that is expected to result from variations in the translational speed of a GPR unit. GPR units are frequently configured on a wheeled platform meant to be pushed by a human operator like a lawn mower or a cart. FIG. 1 illustrates a process by which an original B-scan image is modified, or augmented, to simulate such variations, and further illustrates how a set of synthetic B-scan data is generated from one original B-scan image to cover a wide range of variations.

More specifically, with reference to FIG. 1, in step 110 an original B-scan image is read from a known image format, such as bitmap, into an array variable. This step is referred to herein as encoding the B-scan in an array variable. B-scans being inherently two-dimensional images, the array has two dimensions, where each element of the array is defined by its row and column. The elements themselves may include gray scale intensity data, or even color data such as RGB or RGBA. In the example shown in step 110 of FIG. 1 a NumPy array variable is used to encode a B-scan. The person having ordinary skill in the art will understand that NumPy is a publicly available Python library especially suited to scientific computing involving large multidimensional arrays. The person having ordinary skill will further understand that NumPy is not the only available means for conducting computations according to embodiments of the invention. Thus, the invention is not limited to NumPy arrays, nor is the invention limited to the Python language. The person having ordinary skill in the art will be readily able to select appropriate computational means and computer languages from the state of the art as a matter of design choice.

In step 112 of FIG. 1, a first range is defined corresponding to a width of the array subject to a noise-introducing operation. The range can be as low as zero percent and as high as 100 percent of the full width of the array. In the illustrated method the noise-introducing operation is a Gaussian blurring operation; however, the invention is not limited to Gaussian blurring. Other suitable operations, all of which are within the scope of the invention, are any noise introducing operation that mimics the degradation in image quality resulting from variations in the translational speed of the GPR unit. Suitable operations include well-known blurring operations such as, without limitation, average blurring, median blurring, and Poisson blurring. The person having ordinary skill in the art will be readily capable of selecting from known blurring operations as a matter of design choice and adapting them to mimic artifacts resulting from changes in translational speed without undue experimentation.

Continuing with regard to FIG. 1, the range shown in step 112 is defined as a range of percentages % W_{B} of the total array width Wₜₒₜ according to Equations 1 and 2. Equation 1 represents the percentage of the total width Wₜₒₜ of an array subject to blurring operations, where

W_{B} is the number of columns subject to blurring operations.

$$\% {W}_{B} = 100 \times \frac{{W}_{B}}{{W}_{tot}} \qquad ( Eq . l )$$

The value of % W_{B} can take on any value from a minimum (Wₘᵢₙ) to maximum (Wₘₐₓ), as shown in the inequality of Eq. 2. The person having ordinary skill will readily understand that % W_{B} is a discontinuous range rather than a continuous range, because it is a ratio of integer values. Accordingly, the range of Eq. 2 is a discontinuous series of decimal values, wherein the size of the interval between elements of the range depends on the number of columns comprising NumPy.

$${W}_{min} \leq \% {W}_{B} \leq {W}_{max} \qquad ( Eq . 2 )$$

While it is convenient to represent the width of the array subject to a noise-introducing operation (W_{B}) as a quantity relative to total width (Wₜₒₜ), the person having ordinary skill in the art will understand that the range is not limited in this way. Rather, the range can be left in terms of an integer number of columns making up that portion of the total array width subject to the blurring operation e.g., Gaussian blurring. Step 112 also includes selecting a value for % W_{B} from any value within the range defined in Eq. 2. Values of Wₘₐₓ can be any number satisfying the inequality of Eq. 3, and values of Wₘᵢₙ can be any positive value less than Wₘₐₓ (Eq. 4). The selection may be random, or it may be patterned according to one or more of the following rules: (i) the selection may be made in serial order from one end of the range to the other, (ii) the selection may be made in steps of a empirically determined number of range elements e.g. every 10^{th} element from one end of the range to the other, or (iii) selected regions of the range may be omitted from the process of the invention, wherein such cases may be represented as a sum of distinct ranges, each corresponding to an empirical observation. With respect to “(iii)”, for instance, it may be observed that in practice most blurring due to changes in translational speed occur within a plurality of sub-ranges each corresponding to a different kind or source of variation. For example, 5-10% blurring may be characteristic of a first cause, while 45-55% blurring may be characteristic of a second cause.

$$0 < {W}_{max} \leq 100 \% \qquad ( Eq . 3 )$$

$${W}_{min} < {W}_{max} \qquad ( Eq . 4 )$$

In step 114 of FIG. 1, a second range is defined, indicating allowed values of the quantity of contiguous columns forming a blur group (w_{BN}). The term blur group is used herein to denote a group of contiguous columns of the encoded image that are subject to the same blurring operation. The second range is defined by the inequality of Eq. 5. According to embodiments of the invention, columns are a member of no more than one blur group and are subject to no more than one blurring operation.

$$\begin{matrix}{w}_{BN , min} \leq {w}_{B N} \leq {w}_{BN , max} \\ \begin{matrix}where {w}_{BN , max} = p \times {W}_{B} \\ and where 0 < p \leq 1 .\end{matrix}\end{matrix} \qquad ( Eq . 5 )$$

The second range, according to the example illustrated in FIG. 1, is an integer range. As a matter of computational efficiency, the second range can be limited so that the maximum value (w_{BN,max}) does not exceed the total number of columns subject to the blurring operation (W_{B}), or does not exceed a predetermined fraction (p) of W_{B}. Blur group size may also be constrained based on empirical observations of real B-scan images collected under realistic operating conditions. The size of a blur group corresponds to the duration of a translational speed acceleration or deceleration. Limiting w_{BN,max} in this way focuses the training data set on variations that realistically mimic those which the data model will encounter under expected operating conditions. It also eliminates wasted computations where a blur group size w_{BN} is selected that is larger than the number of columns available to form blur groups (W_{B}), producing a result that must be discarded. Limiting w_{BN,max} also has the effect of setting a minimum number of blur groups. In other words, if the maximum value of w_{BN,max} is ⅓W_{B} then there can be no fewer than three blur groups. As described here, the value of w_{BN,max} can vary from one embodiment to another. For instance, some values of w_{BN,max} will permit values of w_{BN} that do not reflect realistic measurement conditions. It is highly unlikely that real data would be collected with such a rapidly varying speed that every column should be treated as a single blur group. On the other hand, embodiments also include creating synthetic data with extreme deviations from observed data to account for extreme conditions that are not produced during real data collection. Such extreme deviations may even include unrealistic data because, according to the methods taught herein, even unrealistic training data still improves performance without introducing biases. The person having ordinary skill in the art will be capable of setting blur group maxima and minima without undue experimentation.

At the other extreme the minimum of w_{BN} (w_{BN,min}) can be any integer less than or equal to w_{BN,max}. The smallest possible value of w_{BN,min} is 0, meaning for a given random selection of w_{BN} where w_{BN} equals zero, no columns will be subjected to blurring. This is not a useful case (w_{BN}=0) because the embodiment will continue to randomly select values of w_{BN} until a number of columns are subjected to blurring that collectively equal W_{B}. Therefore, setting the minimum blur group size to zero will produce wasted computations, degrading the performance of synthetic data production embodiments. By setting the minimum size of blur groups, the value of w_{BN,min} also sets the maximum number of blur groups

$$( \frac{{W}_{B}}{{w}_{BN}} ) .$$

In the extreme case, where w_{BN,min} is 1, the theoretical, though extremely unlikely, maximum number of blur groups is equal to W_{B}. This is unlikely because it would require every random selection from the range of Eq. 5 to be 1. In a very small range 1≤w_{BN}≤10, the probability of such a result is ( 1/10)¹⁰, or one in ten billion.

It is contemplated that the range of allowed blur group sizes may be well in excess of 1-10 in some embodiments. Appropriate blur group sizes (w_{BN}) correspond to the time scales over which scan speed varies. GPR scans are often taken by a manually pushed unit on a wheeled platform, so variations in speed will depend on variables like the operator's gait and the terrain's topology. In an 8-bit grayscale bitmap, a 1 Mb file with equal length and width has about 2828 columns. If the image data represents a single-pass scan 10 ft in length collected over 60 seconds (0.17 ft/s) then a blur group of 1 to 10 contiguous columns represents a speed variation occurring in the space of about 20 to 200 milliseconds. In terms of length scales, the variation would occur over 0.04 to 0.4 inches. Bearing that in mind, appropriate group sizes for manually pushed units will also include groups larger than 10 columns, corresponding to variations occurring on the order of around a second. For the sake of illustration, assume that the average scan speed is 0.17 ft/s, as noted above, and the data file is a 2828 pixel by 2828 pixel 8 bit grayscale bitmap. In a 10 ft. scan collected at 0.17 ft/s, a 1 second variation in speed will correspond to about 47 columns (2828 columns divided by 60 seconds) or 2 inches of translational movement of the GPR unit.

It is clear that scan speed and variations in scan speed can vary over a wide range. Therefore, an appropriate training data set that accounts for all such variations should include a wide range of blur group sizes (w_{BN}). For example, an appropriate range of w_{BN} for manually pushed units is from 1 to 10, 10 to 100, 100 to 500 columns, or any combination thereof. Moreover, it is contemplated that even wider ranges would be necessary to adequately train a data model to read images obtained from scans of extreme terrains. The person having ordinary skill in the art will be able to calculate an appropriate range of blur group sizes based on the teachings of the present invention without undue experimentation.

In step 116 a value is randomly selected from the second range and assigned to a variable w_{BN}, where the N subscript is incremented for each iteration through step 116. Therefore, w_{BN} can be represented as a series W={w_{B1}, w_{B2}, . . . w_{Bn-1}, w_{Bn}). Each value in the series of w_{BN} is subtracted in each iteration of step 118 from the total width of the NumPy array subject to blurring (W_{B}) and the difference is assigned to a variable W_{residual} indicating the remaining number of columns available for blurring operations. Stated differently, in the first iteration of step 116, w_{B1} is selected from the range defined in step 114, and w_{B1} is subtracted from W_{B} to yield W_{residual,1}. In the second iteration of step 116, w_{B2} is selected from the range of step 114 and subtracted from W_{residual,1} to yield W_{residual,2}. This process iterates until W_{residual,N} is less than or equal to the maximum blur group size w_{BN,max}. The step 122 comparison is made according to the following rules:

$$if {W}_{residual , N} \leq {w}_{BN , max} then assign {W}_{residual , N} to a final {w}_{B N} ( {w}_{B n} ) \qquad ( Eq . 6 )$$

$$if {W}_{residual} > {w}_{BN , max} then repeat steps 116 through 122 \qquad ( Eq . 7 )$$

In FIG. 1, step 122 can be phrased in the form of the following question: “is the result of step 118 (W_{residual,N}) less than or equal to the maximum allowed blur group size, w_{BN,max}?” If the answer is “no” then the inequality of Eq. 7 is satisfied, and the process moves to step 126, which is to repeat steps 116 through 122 until the answer to this question is “yes”, meaning inequality Eq. 6 is satisfied. When Eq. 6 is true, the residual W_{residual,N} is assigned to a final w_{BN}, defining the size of the last blur group having size w_{Bn}. Each iteration through step 116 generates a value of variable w_{BN}, the collection thereof forming a list W={w_{B1}, w_{B2}, . . . w_{Bn-1}}. Step 123 generates the final value of w_{BN} (w_{Bn}), which is added to the list as the final member. The complete list of blur group size elements being W={w_{B1}, w_{B2}, . . . w_{Bn-1}, w_{Bn}}.

The elements w_{BN} of list W are each applied to particular columns of NumPy to form corresponding groups of contiguous columns such that no column of NumPy is included in more than one blur group (step 124), and each w_{BN} is so applied no more than once to the array. This process is referred to herein as mapping each selected blur group size to contiguous columns of the array. In step 132, each w_{BN} is used as the kernel of a one-dimensional Gaussian blur operation according to Eq. 8. The result of Eq. 8 is applied to the corresponding blur group (step 134). In step 136 the process of steps 124 through 134 is repeated until the entire list W is exhausted. According to the process illustrated in FIG. 1, no column is subjected to more than one blurring operation. The magnitude of blurring may be constrained to correspond with empirically observed blurring in real B-scan images.

$$G ( {w}_{B N} ) = \frac{1}{√ 2 π {σ}^{2}} {e}^{- \frac{{w}_{B N}^{2}}{2 {σ}^{2}}} \qquad ( Eq . 8 )$$

In step 137 the NumPy array is reconstructed using the blurred columns and the remaining unblurred columns, and the array is written to a new image file. One complete run through the process of FIG. 1 creates a single synthetic B-scan image file. The process is repeated from step 112 until all values of % W_{B} in the inequality Eq. 2 are exhausted, producing a number of synthetic images equal to the number of integer values in the range defined by Eq. 2.

Theoretically, many more unique synthetic images can be created by the process embodied in FIG. 1 by repeating step 124, reapplying the same elements w_{BN} of list W to particular columns until every unique combination is exhausted. Preferably, the combinations would be nondegenerate, although nondegeneracy is not a limitation of the invention. The person having ordinary skill would recognize that producing synthetic image data from every unique combination of elements w_{BN} would produce an extremely large amount of data, much of which may be unrealistic, unnecessary, or otherwise excessive. Accordingly, embodiments reduce the number of permutations by one or more methods including, but not limited to, (i) constraining the size of the spacing between blur groups to selected minimum and/or maximum limits that agree with empirical observation; (ii) constraining the regions of the NumPy array subject blurring e.g., near the beginning or end of a scan; (iii) setting a numerical limit on the quantity of images and/or the quantity of data bytes produced by the embodiment, after which no further synthetic permutations of a particular original image is produced. The number of images can be advantageously set so that additional images would provide a degree of model improvement judged by the person of ordinary skill to be insignificant or unnecessary. According to some embodiments, data augmentations may be made during training. For instance, each image may be augmented during every epoch of model training.

### Synthetic RF Noise

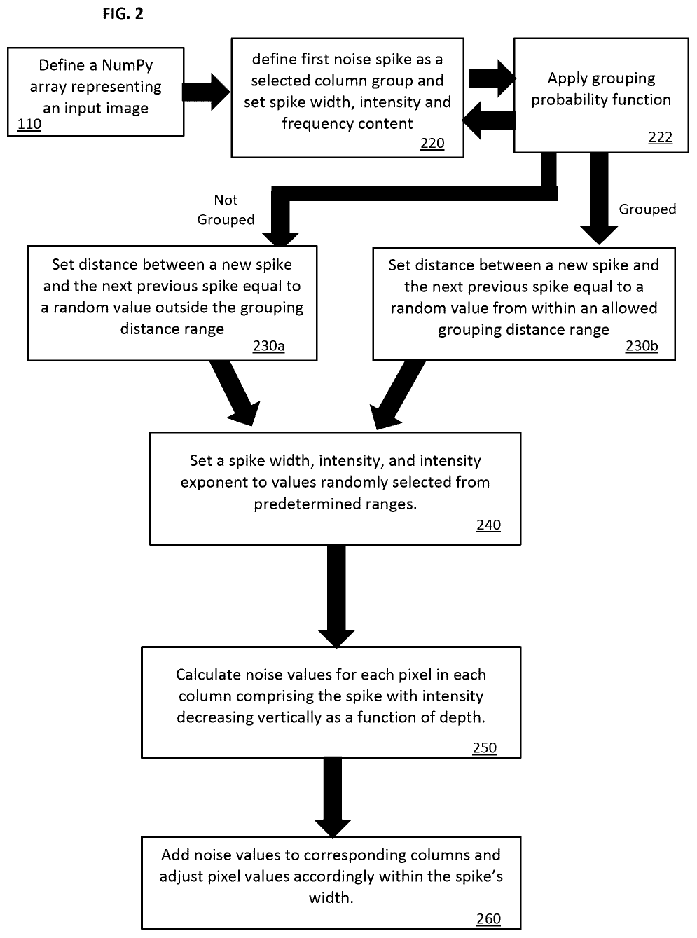

Turning to FIG. 2, a schematic view of another data augmentation method according to an embodiment of the invention is provided, wherein radio frequency (RF) noise is simulated. RF noise spikes are known to be caused and/or influenced by man-made and natural factors. For example, well-known sources include external RF emissions from electronics and other man-made devices, and from stray scatter of natural origin e.g., solar coronal discharges. Soil composition and mineral content also affect RF noise as well as a host of other environmental factors. The synthetic data produced according to the embodiment in FIG. 2 mimics empirically observed RF noise in its intensity, intensity exponent, repetition frequency, and frequency content. The intensity of RF noise occurring in GPR B-scans is expected to be within observed ranges. Further, intensity is depth dependent, where stronger signals are received from sources at shallower depths. Therefore, two identical RF reflectors embedded in identical media at different depths, both receiving from a common above-ground external source, will exhibit different intensities as a function of depth.

Changes in intensity as a function of depth and medium correspond to an intensity exponent (−∈d) according to the Beer-Lambert intensity law as shown in Eq. 9. Beer-Lambert requires that the measured intensity (I) is an exponential attenuation of an initial emission (I₀) as a function of distance from the antenna (d) multiplied by an extinction coefficient (∈). The extinction coefficient is dependent on the chemical composition of the medium through which the radio wave propagates. Furthermore, e applies to any phenomena that attenuates intensity including both absorption and scatter. As shown in Eq. 9, ∈ is the sum of an absorption coefficient (α) and a scattering coefficient (σ) accounting for contributions from both elastic and inelastic scatter. Any material between the source and detector will interact with the RF noise to some degree, and will therefore attenuate the intensity of the noise as a function of the distance it travels through the material (d) and the strength of the interaction (∈). The emission's intensity detected at the antenna is/in Eq. 9. The allowed range of intensity exponents is also determined by empirical observations. Observed intensity exponents are between 2 and 20, 2 and 10, 2 and 6, or any combination thereof.

$$\begin{matrix}I = {I}_{0} {e}^{- ϵ d} \\ where ϵ = α + σ\end{matrix} \qquad ( Eq . 9 )$$

In addition to intensity and intensity exponent, RF noise can be characterized by periodicity. Stray RF radiation may arrive in a series of spikes at regular time intervals, also referred to as a pulse repetition frequency. For the sake of illustration, internal combustion engines can produce radio frequency emissions in a repeating time series of similar spikes. Each time a cylinder's spark plug fires it produces a broad spectrum RF pulse. Accordingly, RF noise is characterized not only by pulse repetition frequency but also by frequency content of each pulse. This kind of repetitive noise may appear in the B-scan at regular distance intervals because the GPR unit is typically translating at a more or less constant speed. In contrast, the frequency content of each pulse affects its intensity according to Eq. 9 because the extinction coefficient is frequency dependent; electromagnetic waves having different frequencies will interact differently with the same medium. Therefore, the power per unit area (I) felt at the receiver depends on the medium through with the radio wave propagates, the distance between the source and receiver, and the frequency content of the pulse. Generally, higher frequency components of a broadband pulse will interact more strongly, e.g. scatter more efficiently, than lower frequency components according to the relationship of Eq. 10 where Q is scattering efficiency and f is frequency, and the exponent x varies depending on the type of scattering.

$$Q ∝ {f}^{x} \qquad ( Eq . 10 )$$

The embodiment schematically illustrated in FIG. 2 shows how the embodiment introduces synthetic RF noise into a B-scan image obtained through actual measurement. The noise preferably mimics waveforms of empirically observed noise spikes found in actual B-scan data, as well as their repetition frequency, and their frequency content. Furthermore, the synthetic noise is preferably modeled after RF noise recorded under the same conditions that an AI trained with the synthetic data is expected to encounter during operation of a real GPR unit. Step 110 of the method is to encode an original B-scan image into an array variable. This step 110 is identical to step 110 of the process discussed above in relation to FIG. 1.

The process that follows inserts a first noise spike in a random position on the distance axis (x-axis) in step 220. A plurality of columns of the NumPy array are selected and designated as comprising the first noise spike to be incorporated into a B-scan by the embodiment. In some embodiments the position of the peak is fixed by selecting a single column and then applying a selected width to add contiguous columns, taking the selected column as the center of the spike. This is merely an illustrative example of how embodiments position the first spike, and is not intended to be a limitation of the invention. The person having ordinary skill in the art will recognize that noise spike position can be fixed by other known methods, otherwise consistent with the claimed invention, as a matter of design choice.

The allowable range of spike widths is determined empirically. In theory, the width take on any value up to the full width of the array variable. As a practical matter, the RF noise typically observed GPR B-scans such as those described herein tend to be between 1 and 20 pixels, 1 and 10 pixels, 2 and 7 pixels, or any combination thereof. Along the distance axis, each pixel corresponds to the minimum horizontal sampling distance of the GPR unit.

The allowed range of intensity is anywhere between 0 and 255, corresponding to the full range of an 8-bit image. The person having ordinary skill in the art will readily understand that the units of intensity need not be expressed in terms of digital image value, but rather may include physical units. As a matter of convenience digital image units may be preferred for conducting computations according to methods of the invention. Furthermore, it will be understood by the person having ordinary skill that noise spike intensity is not limited by any aspect of the invention. Such signals take on arbitrary values. The range of allowed values is determined empirically based on observed intensities. The observed intensity itself depends on the actual intensity of real noise spike and the dynamic range of the detector.

The first spike's width, intensity, intensity exponent, and optionally its frequency content, are selected from predetermined allowed ranges based on empirical observations. These ranges are referred to herein as the spike width range, the intensity range, the intensity exponent range, and the frequency bandwidth range. As a general matter all three ranges are all defined prior to the steps of generating synthetic noise spikes. Once the spike is fully defined by a position, width, intensity and intensity coefficient, the result is used to calculate noise values for each pixel of each column comprising the spike which is then added to the corresponding columns by adjusting pixel values (e.g. grayscale values) accordingly.

With respect to frequency content, it is contemplated that the invention may be embodied in forms that include explicit frequency contents. In other words, the spike might be designated as having a broadband frequency content comprising frequencies f₁, f₂ . . . fₙ. In such embodiments, each frequency will be assigned an intensity that collectively sum to the intensity selected from the allowed values of intensity. Further, in such embodiments the intensity exponent will be similarly decomposed into components that each correspond to the medium's extinction coefficient at each frequency. However, this is optional and not a limitation of the invention. The person having ordinary skill will recognize that frequency content and the frequency dependence of a given medium can be modeled or mimicked without identifying specific frequencies or specific extinction coefficients. All such known methods are within the scope of the invention

The next step (222) is to apply a grouping probability function to determine whether the next pulse is grouped with the first pulse. In this context, the word grouping means to be within defined distance limits from each other. The grouping probability function is used by the embodiment to determine the placement of a given spike. It indicates the probability that the spike will be within a predetermined distance from the next-previous spike. The probability function is determined empirically by an assessment of the frequency with which spikes cluster in real B-scans. More specifically, in the present embodiment, the probability function is determined by the following three steps. First, for each spike that is to be added to the image, the function determines whether or not it should be grouped with the previous spike. Second, a number is sampled from a uniform random distribution such as a Gaussian distribution. If it is less than the empirically determined grouping probability as defined by the user, the new spike will be placed near the previous one, according to a range of allowed values for grouped noise spikes. The range of allowed values is also empirically determined. Third, if the number is not less than the empirically determined grouping probability, the new spike is placed a larger distance away from the next previous spike. However, the person having ordinary skill in the art will readily understand that a probability function according to embodiments of the invention can be determined by other known means as a matter of design choice.

If the result of the probability function indicates that the spike is to be grouped with the next-previous one, then the distance between them is set by selecting a distance value from a predetermined range referred to herein as a grouped range. Alternatively, if the grouping function indicates that the next spike is not to be grouped, then a distance value is selected from a different predetermined range, referred to herein as a non-grouped range. The non-grouped range encompasses the entire width of the B-scan; however, to prevent skewing the results toward grouping, the non-grouped range may exclude the grouped range. The person having ordinary skill in the art will understand that distance values can be selected from the grouped and non-grouped ranges randomly or according to a predetermined pattern.

Both ranges are determined through empirical observations of B-scans recorded under realistic operating conditions. For example, a grouped range can be from less than 1 cm to about 50 cm, which reflects the typical range of the duration of external RF noise in combination with typical GPR scanning speeds, both of which are empirically determined. With respect to the low end of the range, the value can be arbitrarily close to zero, but as a practical matter it is limited by the resolution of the GPR unit, i.e. its capacity to distinguish two spikes on the distance axis. In contrast, the non-grouped range can be anywhere within the B-scan because such interference can occur at any time. Like the spike width range, intensity range, and intensity exponent range, the grouped and non-grouped ranges are defined prior to the steps of generating synthetic noise spikes.

Having determined the next spike's position, its width, intensity, intensity coefficient, and optionally its frequency content, are selected according to the same method as those of the first spike. Similar to the first spike, once it is fully defined, the result is used to calculate noise values for each pixel of each column comprising the spike, which is then added to the corresponding columns by adjusting pixel values accordingly.

### Synthetic Vertical Shift Noise

Embodiments also include a method for simulating vertical movement of the GPR unit, such as would be experienced when pushing a wheeled GPR unit over rocky or uneven terrain. GPR units are often used on soil at construction sites. The ground in such an area is very likely to provide an uneven or unstable substrate. Small vertical motions of the receiving antenna can cause some A-scans to shift vertically during the measurement. The effect on B-scans is to introduce groups of contiguous vertically shifted columns. Such anomalies can cause a data model to misidentify structures or fail to identify them altogether unless its training data includes the same anomalies. Accordingly, it is desirable to provide a training data set that includes synthetic data mimicking the full spectrum of vertical shifts that the AI is likely to encounter under operating conditions.

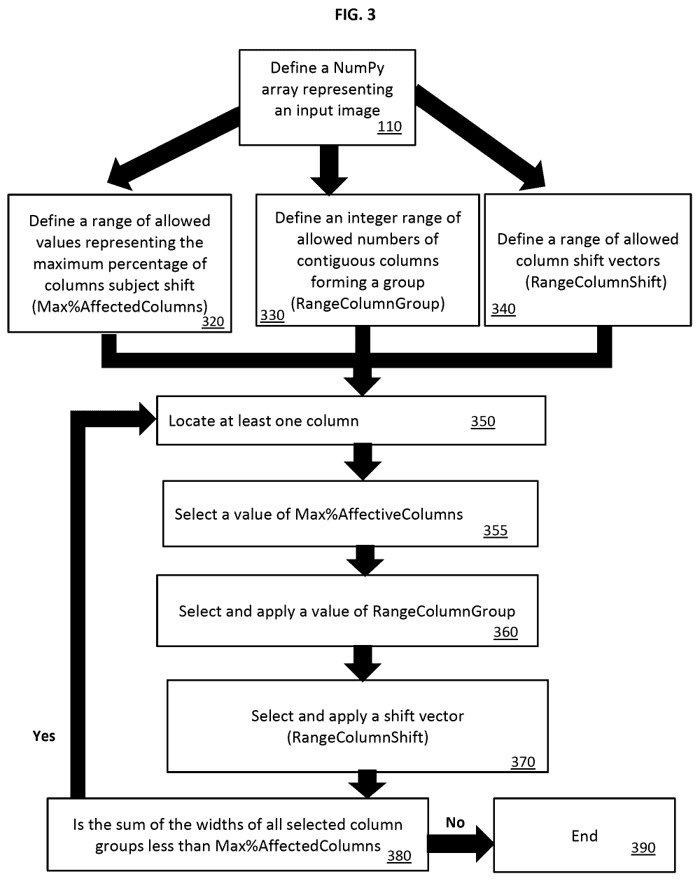

An embodiment for producing synthetic vertical shift augmentations in GPR B-scan data is schematically illustrated in FIG. 3. The first step 110 is the same as that of the embodiments already described in relation to FIGS. 1 and 2. That is, to encode a GPR B-scan image from an image data file into an array variable, which in this embodiment is a NumPy array. Three different steps (320, 330, and 340) occur more or less in parallel. The placement of these steps after step 110 does not necessarily mean that they occur later in time than step 110.

In step 320 the embodiment defines a range of maximum percentages representing the maximum proportion of columns in the array that are subject to vertical shift operations relative to the total number of columns in the array. The cumulative number of columns subjected to vertical shift operations in producing one synthetic image, cannot exceed the selected maximum. This range corresponds to the variable, Max%AffectedColumns. The person of ordinary skill will understand that this range can alternatively be represented as an integer range without departing from the invention. In step 330 the embodiment defines an integer range representing allowed values of RangeColumnGroup, which is the number of contiguous columns forming a group subject to a single vertical shift operation.

In step 340 the embodiment defines another integer range representing allowed values of the column shift vector. The vector can be defined in terms of pixel quantity. A column shift vector is a one-dimensional vector indicating the direction of shift, up or down, and the magnitude of shift, measured in pixels. The person having ordinary skill will immediately recognize that the units can be other than pixels, including any convenient length unit. The person of ordinary skill will also readily recognize that shift vectors can be represented in two-dimensions, as the B-scan is two-dimensional; however, the shift contemplated by the illustrated embodiment is up or down along the vertical axis. Therefore, the horizontal component is always zero in this embodiment. To the extent that vertical shift artifacts can have a non-zero horizontal component in other embodiments, the vertical shift vector would preferably be represented in two-dimensions.

In step 350 at least one column is selected to define the x-axis position of a group of columns to be shifted. The column can be selected at random or according to a predetermined pattern. In step 355 a value of Max%AffectedColumns is selected from the range defined in step 320. In step 360 a value is selected from the range defined in step 330 and applied by defining a group width at the location of the column selected in step 350. In step 370 a shift vector (RangeColumnShift) is selected from the range defined in step 340 and applied by shifting the pixels of the column group vertically in accord with the shift vector. Some portion of the pixels will be shifted outside the bounds of the image, essentially deleting them. The portion of the pixels remaining in-frame are then vertically stretched to fit the original image dimensions. In step 380 the process asks whether the sum of the columns subjected to shift, in proportion to the total number of columns in the array, is less than Max%AffectedColumns. If the answer is yes, then the process continues by reiterating the steps starting from 350. If the answer is no, then the process ends at step 390 and the array is written back to an image file and recorded. With respect to negative answers, it is contemplated that a final iteration of the process may exceed Max%AffectedColumns. The degree to which the final iteration exceeds Max%AffectedColumns will be negligible in most cases. Thus, such excesses are still within the scope of the invention. It is intended that the stated rule of not exceeding Max%AffectedColumns should be interpreted as not substantially exceeding, meaning to exceed by not more than a negligible amount. The person having ordinary skill in the art will be capable of deciding whether a result exceeding Max%AffectedColumns is negligible and whether to include the final shifted column group in the augmented image or discard it.

### High-Pass Filtering

GPR data is known to be subject to low frequency noise. Such noise typically originates from induction caused by the GPR unit's radio emissions. More specifically, the magnetic field component of the radio wave can induce currents in buried conductors. These currents result in emissions at a lower frequency. It is also known that dynamic range limitations of a radio receiver antenna can cause spurious low frequency signals that can interfere with GPR signals. In the context of GPR signal processing, the process of filtering out this kind of low frequency noise is sometimes referred to as dewowing.

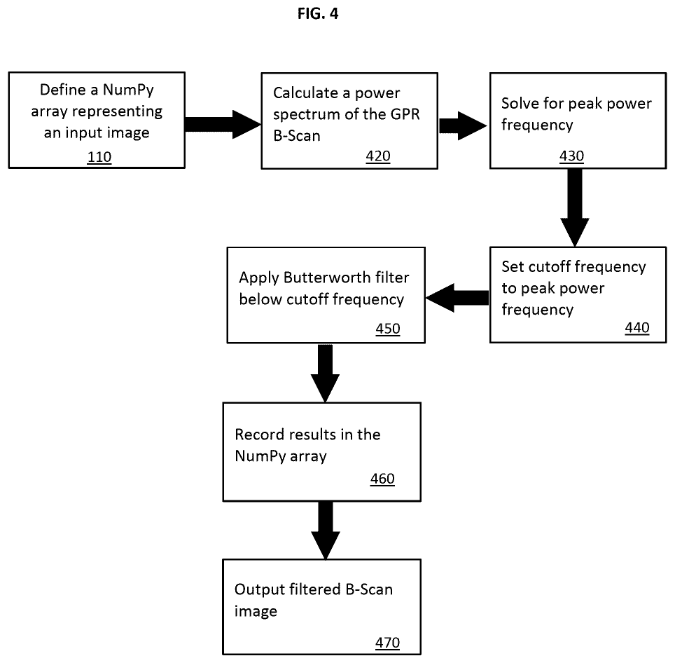

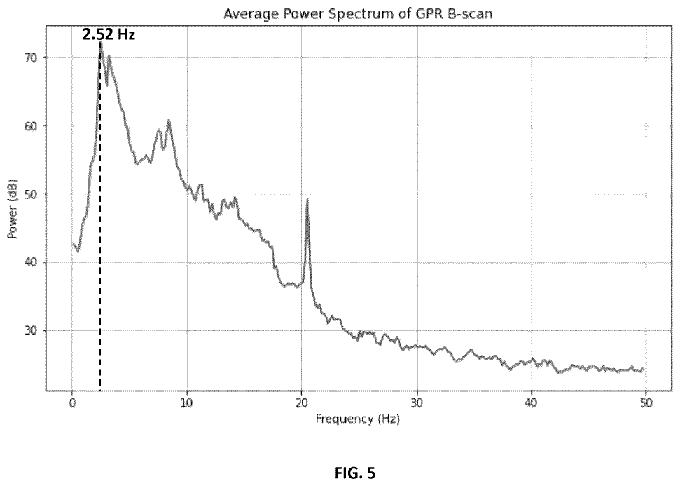

Some embodiments of the invention include processes for dewowing. One such embodiment is illustrated schematically in FIG. 4. The first step of the process (110) has already been described in detail in relation to other data augmentation methods according to the invention. In the second step (420), the power spectrum of the GPR B-scan encoded in the NumPy array is calculated by applying a Fourier Transform. The result is a plot like that of FIG. 5 showing a frequency domain spectrum with power on the vertical axis and frequency on the horizontal axis. In step 430, the spectrum is solved for peak power and the frequency at peak power is recorded. In FIG. 5 that frequency is 2.52 Hz. This frequency is used as the cutoff frequency for a high-pass filter. In step 440 the cutoff frequency is set accordingly. Frequencies below the cutoff are either attenuated or neglected entirely. In step 450 the high-pass filter is applied. One kind of signal processing filter that is suitable for embodiments of the invention is a Butterworth filter, preferably a 5^{th} order Butterworth filter. While other high-pass filters are within the scope of the invention, the advantage of a Butterworth filter is its relatively flat frequency response in the passband. Butterworth filters lack the ripple artifacts found in other filter types. Further, the transition from the passband to the stopband is generally smooth compared to other filters, again causing less distortion in the B-scan. One disadvantage of the Butterworth filter is that it tends not to attenuate as sharply under the passband. The order of the Butterworth filter corresponds to the number of reactive components e.g., inductors or capacitors, in the filter. Generally, the higher the order the steeper the slope of the roll-off. The magnitude response of a Butterworth filter is given by Eq. 11.

$$\vert H ( j ω ) \vert = \frac{1}{\sqrt{1 + {( \frac{ω}{{ω}_{c}} )}^{2 n}}} \qquad ( Eq . 11 )$$

where,
ω is angular frequency
ω_{c} is cutoff frequency and
n is the order of the filter

In contrast to the other methods taught by the present disclosure, the low-pass filter method of the invention is intended to remove features from training data rather than add features to training data.

Embodiments further include applying a plurality of the augmentation methods taught herein to a real B-scan image to produce synthetic noise mimicking (i) blurring due to variations in translational speed of a GPR unit, (ii) radio frequency interference noise, and/or (iii) vertical column shifts due to vertical motion of the GPR unit. In combination with one or more of (i) through (iii), embodiments may further include (iv) augmenting the B-scan image by subtracting a low frequency region of an energy spectrum of the B-scan image below a cutoff frequency. Accordingly, a single synthetic B-scan image may be the product of all the data augmentation methods taught herein, any combination thereof, or a single data augmentation method.

It will be apparent to those skilled in the art that the above methods and apparatuses may be changed or modified without departing from the general scope of the invention. The invention is intended to include all such modifications and alterations insofar as they come within the scope of the appended claims or the equivalents thereof.

Having thus described the invention, it is now claimed:

I claim:

1. A data augmentation method comprising the steps of:
encoding a B-scan image as an array variable having a width corresponding to a number of columns;
defining a first range corresponding to a width of the array subject to a noise-introducing operation;
selecting a value from the first range;
defining a second range as an integer range defining numbers of contiguous columns of the array, each number defining a size of a blur group;
selecting a plurality of blur group sizes from the second range, wherein the sum of the selected blur group sizes numerically corresponds to the value selected from the first range corresponding to a number of columns of the array subject to the noise-introducing operation;
mapping each selected blur group size to contiguous columns of the array;
applying the noise-introducing operation to each blur group; and
encoding an augmented B-scan image.

2. The data augmentation method of claim 1, wherein the B-scan image comprises ground penetrating radar data.

3. The data augmentation method of claim 1, wherein the first range is a discontinuous range of percentages of a total width of the array.

4. The data augmentation method of claim 3, wherein the percentage range is from 0% to 100%.

5. The data augmentation method of claim 4, wherein an interval from one element of the percentage range to its nearest neighbor is from 0.01% to 25%.

6. The data augmentation method of claim 1, wherein the first range is an integer range, each element of the range corresponding to a width of the array.

7. The data augmentation method of claim 6, wherein an interval from one element of the integer range to its nearest neighbor is from 1 to 1000.

8. The data augmentation method of claim 1, wherein the noise-introducing operation comprises one or more of a Gaussian blur operation, an average blur operation, a median blur operation, or a Poisson blur operation.

9. The data augmentation method of claim 1, wherein the step of mapping comprises selecting contiguous groups of columns of the array to each correspond to one selected blur group size such that the number of columns in each selected contiguous group of columns equals the value of the corresponding blur group size.

10. The data augmentation method of claim 1, further comprising repeating the step of randomly selecting a value from the first range, until all array widths corresponding to elements of the first range have been randomly selected.

11. The data augmentation method of claim 10, wherein the selected elements of the first range collectively comprise substantially all of the first range.

12. The data augmentation method of claim 11, wherein the encoded augmented B-scan image comprises a plurality of encoded augmented B-scan images, wherein each of the plurality of encoded augmented B-scan images corresponds to one element of the first range, and wherein the plurality of encoded augmented B-scan images comprise a set of synthetic images.

13. A data augmentation method, the method comprising the steps of:
encoding a B-scan image as an array variable having a width corresponding to a number of columns;
defining a grouped range corresponding to allowed spacing values between grouped noise spikes;
defining a non-grouped range corresponding to allowed spacing values between non-grouped noise spikes;
defining a spike width range corresponding to allowed spike widths of noise spikes;
defining a spike intensity range corresponding allowed noise spike intensity values;
defining a spike intensity exponent range corresponding to allowed noise spike intensity exponent values;
defining a spike frequency content range corresponding to allowed frequency contents of noise spike frequency content values;
encoding a B-scan image as an array variable having a width corresponding to a total number of columns of the array;
designating a selected first group of columns of the array as comprising a first noise spike;
setting a spike width of the first spike to a value selected from the spike width range;
setting a spike intensity of the first spike to a value selected from the spike intensity range;
setting a spike intensity exponent of the first spike to a value selected from the spike intensity exponent range;
calculating noise values for each pixel in each column of the first group of columns;
adding the noise values to each pixel in each column of the first group of columns;
determining whether to group the first noise spike with a next noise spike based on a grouping probability function;
setting a distance between the first noise spike and the next noise spike to a value selected from the grouped range or the non-grouped range based on the outcome of the step of determining whether to group the first noise spike with the next noise spike;
selecting a next group of columns according to the distance set between the first noise spike and the next noise spike, and designating the next group of columns as comprising the next noise spike;
setting a spike width of the next spike to a value selected from the spike width range;
setting a spike intensity of the next spike to a value selected from the spike intensity range;
setting a spike intensity exponent of the next spike to a value selected from the spike intensity exponent range;
calculating noise values for each pixel in each column of the next group of columns; and
adding the noise values to each pixel in each column of the next group of columns.

14. The data augmentation method of claim 13, wherein the grouped range is from less than 1 cm to 50 cm.

15. The data augmentation method of claim 13, wherein the non-grouped range is a full width of the array variable.

16. The data augmentation method of claim 13, wherein the spike width range is from 2 to 7 pixels.

17. The data augmentation method of claim 13, wherein the intensity range is from 0 to 255.

18. The data augmentation method of claim 13, wherein the intensity exponent range is from 2 to 6.

19. The data augmentation method of claim 13, further comprising the steps of:
setting a spike frequency content of the first spike to a value selected from the spike frequency content range; and
setting a spike frequency content of the next spike to a value selected from the spike frequency content range.

20. The data augmentation method of claim 19, wherein the step of setting a spike frequency content of the first spike, and the step of setting a spike frequency content of the next spike, both further comprise setting the intensity of each frequency of the spike frequency content such that their sum is equal to the selected intensity, and assigning an intensity exponent to each frequency of the spike frequency content such that their sum is equal to the selected intensity exponent.

21. A data augmentation method comprising the steps of:
encoding a B-scan image as an array variable having a width corresponding to a number of columns;
defining a range of allowed maximum number of columns of the array variable subjected to a vertical column shift operation;
defining an integer range of allowed contiguous columns forming a group;
defining a range of allowed column shifts;
selecting a group of columns of the array in accordance with the range of allowed contiguous columns;
selecting a value from the range of allowed maximum number of columns; and
apply a column shift in accordance with the range of allowed column shifts.

22. The data augmentation method of claim 21, wherein the allowed column shifts are one or two dimensional shift vectors.

23. The data augmentation method of claim 21, further comprising the step of comparing a sum of all columns subjected to at least one column shift operation to the selected value of allowed maximum number of columns.

24. The data augmentation method of claim 23, further comprising repeating the steps of:
selecting a group of columns of the array in accordance with the range of allowed contiguous columns;
selecting a value from the range of allowed maximum number of columns; and
apply a column shift in accordance with the range of allowed column shifts, wherein the steps are repeated until the sum of all columns subjected to at least one column shift operation is at least equal to the selected value of allowed maximum number of columns.

25. A data augmentation method, the method comprising the steps of:
encoding a B-scan image as an array variable having a width corresponding to a number of columns;
calculating a power spectrum from the encoded B-scan image;
solving for frequency at peak power;
setting a cutoff frequency to the frequency at peak power;
applying a high-pass filter to the encoded B-scan image having the cutoff frequency;
recording to the array variable the results of applying the high-pass filter; and
outputting a filtered image.

26. The data augmentation method of claim 25, wherein the high-pass filter is a Butterworth filter.

27. The data augmentation method of claim 26, wherein the Butterworth filter is fifth order.

28. A data augmentation method, the method comprising the steps of:
encoding a B-scan image as an array variable having a width corresponding to a number of columns;
augmenting the B-scan image by adding synthetic noise mimicking blurring due to variations in translational speed of a GPR unit;
augmenting the B-scan image by adding synthetic noise mimicking radio frequency interference noise;
augmenting the B-scan image by adding synthetic noise mimicking vertical column shifts due to vertical motion of the GPR unit; and
augmenting the B-scan image by subtracting a low frequency region of an energy spectrum of the B-scan image below a cutoff frequency.
